(19) United States
(12) Patent Application Publication
(10) Pub. No.: US 2012/0130645 A1
(43) Pub. Date: May 24, 2012

(54) METHOD AND APPARATUS FOR MEASURING BODY IMPEDANCE BASED ON BASEBAND SIGNAL DETECTION

(75) Inventors: Harinath Garudadri, (US); Pawan K. Baheti, San Diego, CA (US); Somdeb Majumdar, San Diego, CA (US)

(73) Assignee: QUALCOMM Incorporated, San Diego, CA (US)

(21) Appl. No.: 13/110,066

(22) Filed: May 18, 2011

Related U.S. Application Data
(60) Provisional application No. 61/360,310, filed on Jun. 30, 2010.

(51) Int. Cl. G01N 27/02

(52) U.S. Cl. 702/19

(57) ABSTRACT

Certain aspects of the present disclosure relate to techniques for measuring body impedance based on baseband signal detection in analog domain. Proposed methods and apparatus are able to measure an impedance of human body based on sub-Nyquist sampling of signals. The proposed techniques can be particularly beneficial for reducing overall sensor power when an actuation signal generates electrical signals corresponding to vital signs in humans.

### CLAIM OF PRIORITY UNDER 35 U.S.C. §119

The present Application for Patent claims benefit of U.S. Provisional Patent Application Ser. No. 61/360,310, entitled, “Method and apparatus for measuring body impedance based on baseband signal detection”, filed Jun. 30, 2010 and assigned to the assignee hereof and hereby expressly incorporated by reference herein.

### BACKGROUND

1. Field

Certain aspects of the present disclosure generally relate to signal processing and, more particularly, to a method and apparatus for measuring body impedance based on baseband signal detection.

2. Background

Wireless body area networks (BANs) technology, specifically BAN technology for sensing and transmitting biophysical signals wirelessly, can be useful for treatment and prevention of chronic ailments; promoting health and fitness with life style changes, and alike. In one approach, measuring body impedance can be used to determine biophysical signals of interest. It is desirable to reduce overall sensor power when an actuation signal is required to generate electrical signals corresponding to vital signs in humans. For applications like estimating a respiration rate, it would be desirable to quantify the respiration rate directly without requiring high-frequency analog-to-digital converters and digital processing.

Consequently, it is desirable to address one or more of the deficiencies described above.

### SUMMARY

Certain aspects of the present disclosure provide an apparatus. The apparatus generally includes a signal generator configured to provide a first signal to a body, a first circuit configured to obtain, in response to the first signal, a second signal associated with the body, a second circuit configured to estimate in analog domain a baseband signal from the second signal, and a third circuit configured to sample the baseband signal after the estimation.

Certain aspects of the present disclosure provide a method. The method generally includes providing a first signal to a body, obtaining, in response to the first signal, a second signal associated with the body, estimating in analog domain a baseband signal from the second signal, and sampling the baseband signal after the estimation.

Certain aspects of the present disclosure provide an apparatus. The apparatus generally includes means for providing a first signal to a body, means for obtaining, in response to the first signal, a second signal associated with the body, means for estimating in analog domain a baseband signal from the second signal, and means for sampling the baseband signal after the estimation.

Certain aspects of the present disclosure provide a computer-program product. The computer-program product generally includes a computer-readable medium comprising instructions executable to provide a first signal to a body, obtain, in response to the first signal, a second signal associated with the body, estimate in analog domain a baseband signal from the second signal, and sample the baseband signal after the estimation.

Certain aspects of the present disclosure provide a sensing device. The sensing device generally includes a signal generator configured to provide a first signal to a body, a sensor configured to sense, in response to the first signal, a second signal associated with the body, a first circuit configured to estimate in analog domain a baseband signal from the second signal, and a second circuit configured to sample the baseband signal after the estimation.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example of a body area network (BAN) in accordance with certain aspects of the present disclosure.

FIG. 2 illustrates various components that may be utilized in a wireless device of the BAN in accordance with certain aspects of the present disclosure.

FIG. 3 illustrates an example block diagram of a first Electrical Impedance Tomography (EIT) system configured in accordance with certain aspects of the present disclosure.

FIG. 4 illustrates an example block diagram of a Teager demodulator utilized in the EIT system in accordance with certain aspects of the present disclosure.

FIG. 5 illustrates an example block diagram of a second EIT system configured in accordance with certain aspects of the present disclosure.

FIG. 6 illustrates an example block diagram of a third EIT system configured in accordance with certain aspects of the present disclosure.

FIG. 7 illustrates an example block diagram of a fourth EIT system configured in accordance with certain aspects of the present disclosure.

FIG. 8 illustrates an example block diagram of an apparatus of an EIT system for measuring body impedance in accordance with certain aspects of the present disclosure.

FIG. 9 illustrates an example block diagram showing the functionality of an apparatus of an EIT system for measuring body impedance in accordance with certain aspects of the present disclosure.

FIG. 10 illustrates example operations that may be performed at a sender device of an EIT system in accordance with certain aspects of the present disclosure.

FIG. 10A illustrates example components capable of performing the operations illustrated in FIG. 10.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### AN EXAMPLE WIRELESS COMMUNICATION SYSTEM

The techniques described herein may be used for various broadband wireless communication systems, including communication systems that are based on an orthogonal multiplexing scheme and a single carrier transmission. Examples of such communication systems include Orthogonal Frequency Division Multiple Access (OFDMA) systems, Single-Carrier Frequency Division Multiple Access (SC-FDMA) systems, Code Division Multiple Access (CDMA), and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A CDMA system may utilize spread-spectrum technology and a coding scheme where each transmitter (i.e., user) is assigned a code in order to allow multiple users to be multiplexed over the same physical channel.

The teachings herein may be incorporated into (e.g., implemented within or performed by) a variety of wired or wireless apparatuses (e.g., nodes). In some aspects, a node comprises a wireless node. Such wireless node may provide, for example, connectivity for or to a network (e.g., a wide area network such as the Internet or a cellular network) via a wired or wireless communication link. In some aspects, a wireless node implemented in accordance with the teachings herein may comprise an access point or an access terminal.

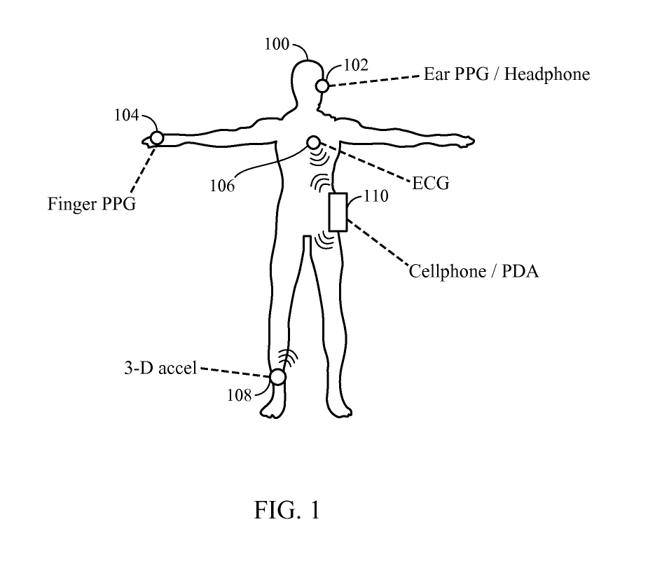

Certain aspects of the present disclosure may support methods implemented in body area networks (BANs). The BANs represent promising concept for healthcare applications such as continuous monitoring for diagnostic purposes, effects of medicines on chronic ailments, and alike. FIG. 1 illustrates an example of a BAN 100 that may comprise several acquisition circuits 102, 104, 106, 108. Each acquisition circuit may comprise wireless sensor that senses one or more vital biophysical signals and communicates them (e.g., over a wireless channel) to an aggregator (a receiver) 110 for processing purposes.

The BAN 100 may be therefore viewed as a wireless communication system where various wireless nodes (i.e., acquisition circuits and aggregator) communicate using either orthogonal multiplexing scheme or a single carrier transmission. The aggregator 110 may be a mobile handset, a wireless watch, a headset, a monitoring device, or a Personal Data Assistant (PDA). As illustrated in FIG. 1, an acquisition circuit 102 may correspond to an ear photoplethysmograph (PPG) sensor, an acquisition circuit 104 may correspond to a finger PPG sensor, an acquisition circuit 106 may correspond to an electrocardiogram (ECG) sensor (or an electroencephalogram (EEG) sensor), and an acquisition circuit 108 may correspond to a 3D-Accelerometer (3D-Accl) sensor. In an aspect, the acquisition circuits in FIG. 1 may operate in accordance with compressed sensing (CS), where an acquisition rate may be smaller than the Nyquist rate of a signal being acquired.

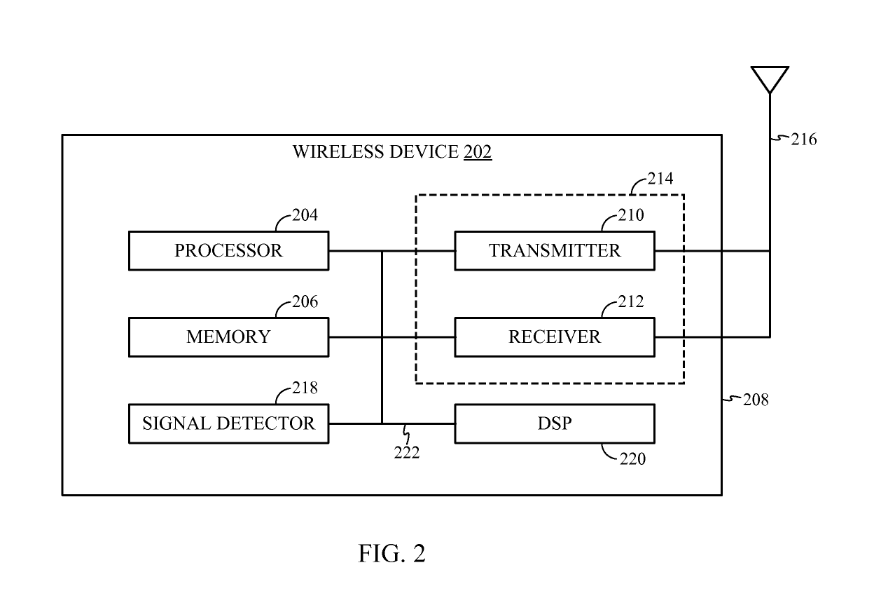

FIG. 2 illustrates various components that may be utilized in a wireless device 202 that may be employed within the BAN 100. The wireless device 202 is an example of a device that may be configured to implement the various methods described herein. The wireless device 202 may correspond to the aggregator 110 or to one of the acquisition circuits 102, 104, 106, 108.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

Certain aspects of the present disclosure support methods and apparatus measuring an impedance of human body (e.g., a body of the BAN 100 from FIG. 1) based on sub-Nyquist sampling of signals associated with the body. The techniques proposed in the present disclosure may be particularly beneficial for reducing overall sensor power when an actuation signal is required to generate electrical signals corresponding to vital human signs.

### Electrical Impedance Tomography

Electrical Impedance Tomography (EIT) is an imaging modality that reconstructs the cross-sectional images of electrical impedivity distribution within the body by making voltage or current measurements through electrodes attached around the body. Different biological tissues exhibit different electrical resistivity. For example, electrical resistivity ranges from 0.65 mΩ for cerebrospinal fluid, increasing through blood, muscle and fat to 166 mΩ for bone. The physiological events in the body, such as cardiac and respiration activity, result in variations across tissue resistivity—allowing EIT to produce functional images. The basic data collection process for traditional EIT can be achieved by injecting sinusoid current signals with frequencies ranging from 1 kHz to 100 kHz (depending on a type of tissue being imaged or activity being monitored), and observing the potential difference between an independent set of adjacent electrode pairs attached on the body.

The basic stages to produce an impedance image can be twofold: collection of a set of M independent transfer impedance measurements (e.g., with N electrodes, N·(N−3)/2 independent voltage measurements may be obtained with single pair of current-drive electrodes); and solution of an inverse problem in order to produce an image from the set of transfer impedances. Typical EIT based imaging systems may comprise, for example, 16 to 32 electrodes.

One advantage of the EIT is that this technology is relatively inexpensive compared to Computed Tomography (CT) and Magnetic Resonance Imaging (MRI) technologies. Further, the EIT is a non-invasive technique, and it is suitable for long-time monitoring of physiological functions. One possible disadvantage of EIT can be that it may offer spatial resolution of a lower quality compared to CT and MRI-based modalities.

In one aspect of the measurement system described in the present disclosure, EIT modality may be used to extract the respiration rate of a subject. Two electrodes may be attached to the subject, through which an electrical current may be injected and a potential difference may be subsequently measured. In an aspect, the respiration rate may be determined using a Teager demodulator integrated in the system.

### Methods for Measuring Body Impedance Based on Baseband Signal Detection

Certain aspects of the present disclosure address power consumption and quality of reconstruction for EIT based respiration rate detection. Several methods are proposed for reducing system power consumption by applying a Teager-operator based demodulation in analog domain. This may reduce the burden of high frequency analog-to-digital converters that would be utilized if the carrier signal was demodulated in digital domain. The proposed approach may be combined with compressed sensing at a sensor front-end to reduce sensing and transmission power. Furthermore, a method is proposed in the present disclosure to adapt carrier frequency characteristics to the measurement quality during operation. In this way, overall signal-to-noise ratio (SNR) may be improved over time.

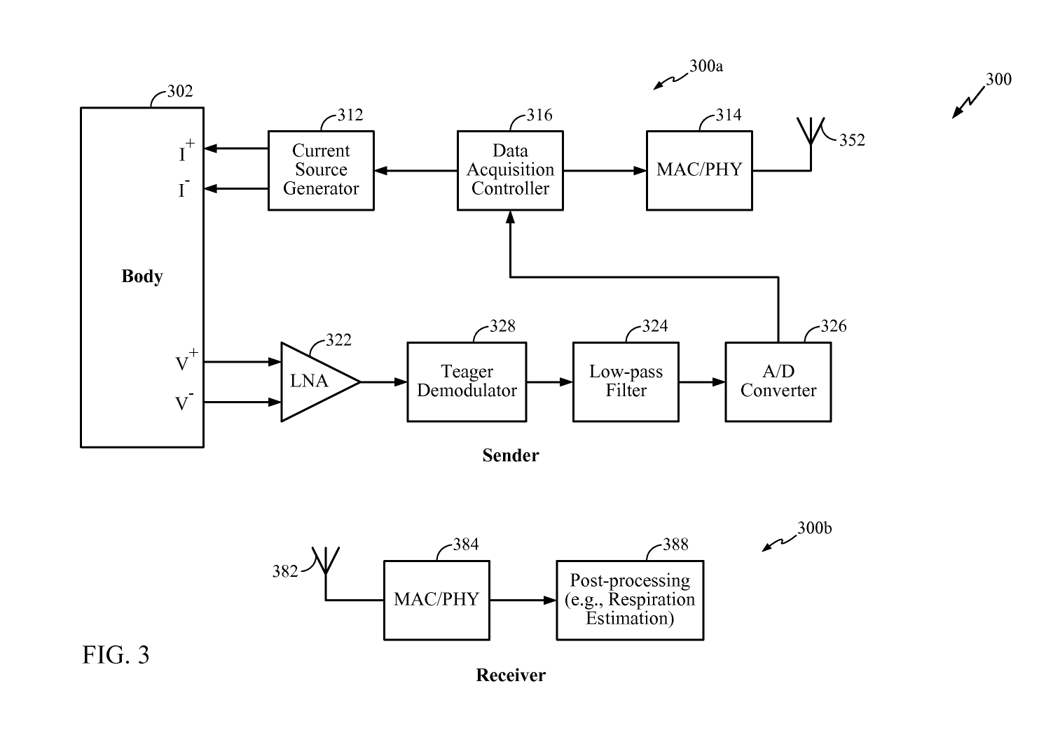

FIG. 3 illustrates an example system 300 based on EIT for determining a respiration rate of human body, wherein the system 300 may comprise a sender 300a and a receiver 300b. In an aspect of the present disclosure, the system 300 may be an integral part of the BAN 100 from FIG. 1, and at least one of the sender 300a or the receiver 300b may correspond to the wireless device 202 from FIG. 2.

The sender 300a may comprise a Teager demodulator 328 coupled to a Low Noise Amplifier (LNA) or a sensor 322 that may be connected to a body 302. The output of Teager demodulator 328 may be coupled to a low-pass filter 324, which may be itself coupled to an analog-to-digital (A/D) converter 326. The output of A/D converter 326 may be then sent to a data acquisition controller 316 for packetizing and transmission using a MAC/PHY module 314 and an antenna 352. The data acquisition controller 316 may also control a current source generator 312, which may generate the initial input for the body 302.

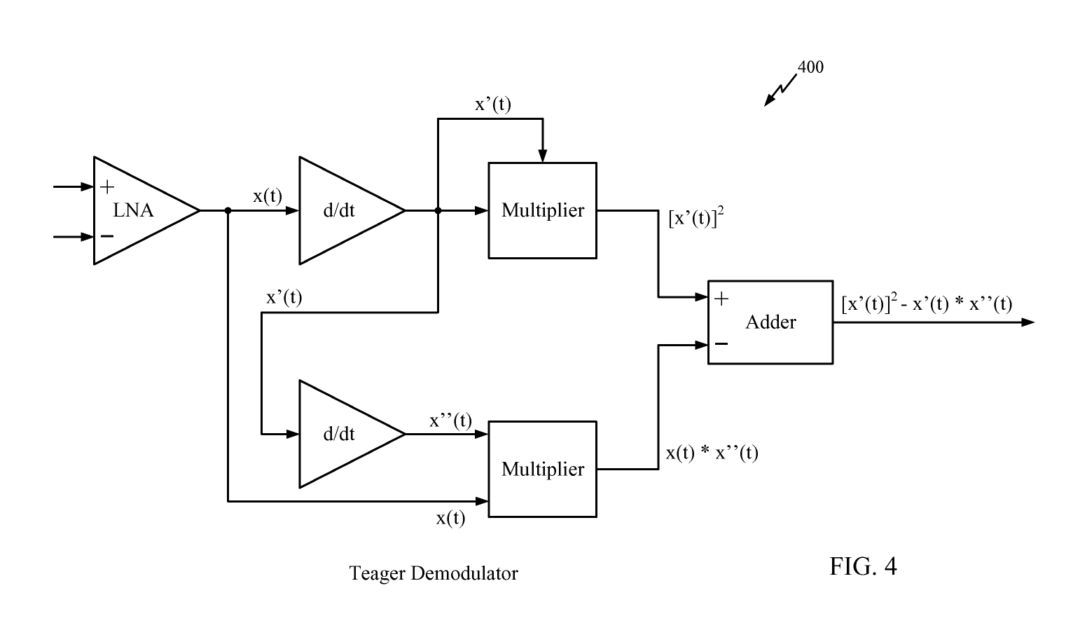

The signal transmitted from the sender 300a may be then received at the receiver 300b via an antenna 382 and MAC/PHY 384, and it may be then input into a post-processing module 388 for estimating the respiration rate from the digitized version of signal obtained by the Teager demodulator 328 at the sender side. In a preferred aspect of the method proposed in the present disclosure, the Teager demodulation may extract the information signal from the sensed voltage waveform. The low-pass filtered version of the demodulated signal may be digitized followed by respiration rate extraction. FIG. 4 illustrates implementation details of a Teager demodulator 400 in analog domain that may correspond to the Teager demodulator 328 from FIG. 3. According to certain aspects of the present disclosure, the Teager demodulators 328 and 400 may be implemented in analog domain.

Advantages of the aforementioned approach illustrated in FIG. 3 over the traditional EIT data acquisition method includes that the extraction of information signal may be achieved without creating analog sinusoid current signals for demodulation patterns. The traditional EIT-based systems utilize high-end A/D converters (e.g., sampling frequencies greater than 1 kHz) to sense the potential difference and then extract the respiration rate. With the proposed method, an A/D converter with the desired sampling frequency being less than 10 Hz may be used.

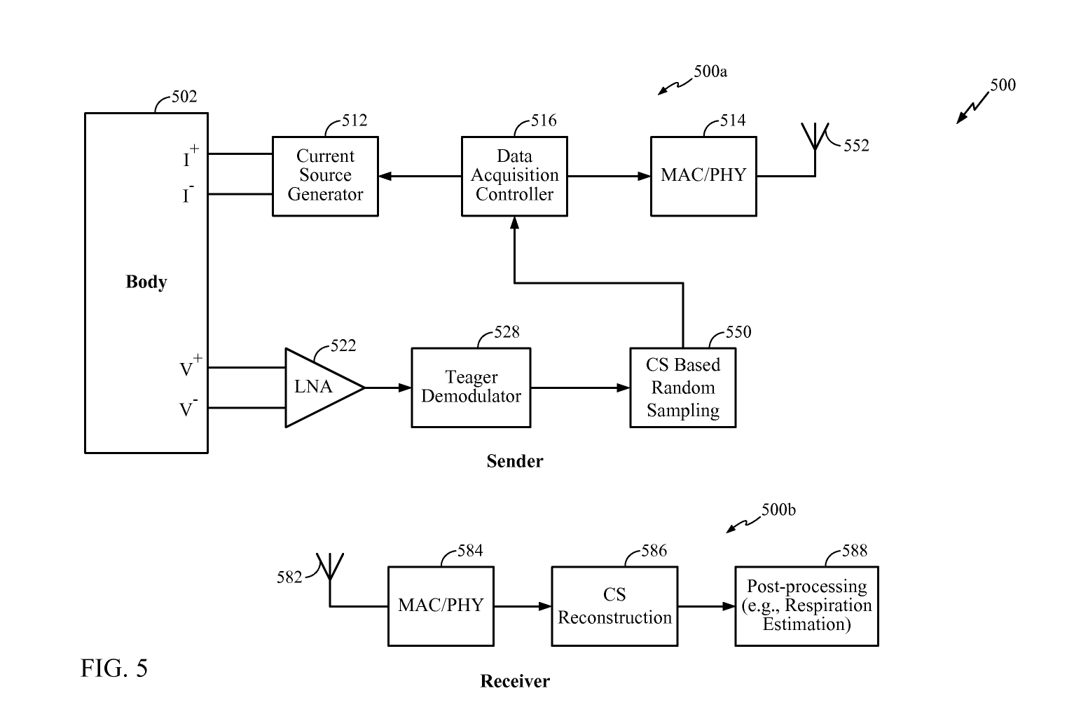

FIG. 5 illustrates another example system 500 based on EIT for determining the respiration rate of human body, wherein a Teager-demodulated output may be directly subjected to compressed sensing (CS) utilizing a CS-based random sampling module 550. The modules and elements illustrated in FIG. 5 are described and operate similarly as the similarly numbered modules in previous figures, except that the first number corresponds to the figure (e.g., the description for the MAC/PHY 514 is the same as the description for the MAC/PHY 314, etc.).

The compressed sensing, also referred to as compressive sampling, compressive sensing, or sparse sampling, is a technique for acquiring and reconstructing a signal utilizing some prior knowledge, which may be sparse or compressible. The requirement for a low-pass filter (e.g., the low-pass filter 324 from FIG. 3) may be eliminated by using the approach illustrated in FIG. 5. On a receiver 500b, a CS reconstruction module 586 may be applied to reconstruct the transmitted signal from a sender 500a before being sent to a post-processing module 588 for respiration rate estimation.

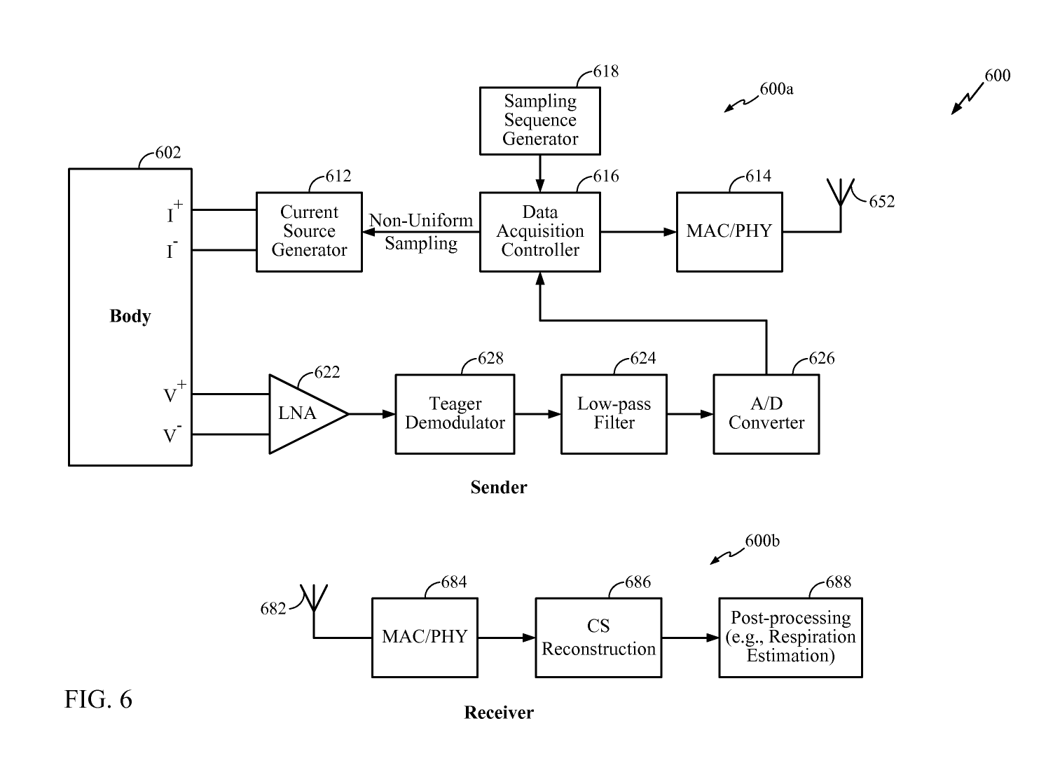

FIG. 6 illustrates another example system 600 based on EIT for determining the respiration rate of human body, where a current source 612 may be actuated at non-uniform time instants based on operation of a sampling sequence generator 618. The modules and elements shown in FIG. 6 are described and operate similarly as the similarly numbered modules in previous figures, except that the first number corresponds to the figure (e.g., the description for the MAC/PHY 614 is the same as the description for the MAC/PHY 514, etc.).

The actuation of the current sequence by the sampling sequence generator 618 may be at different time intervals, and in one aspect of the approach with two or more of the intervals between the actuation being different. The non-uniform actuation of the current source 612 (i.e., actuation at two or more non-uniform time instants) may result in savings of power on a sensor side 600a, as it may not be required to continuously actuate the source of electrical current.

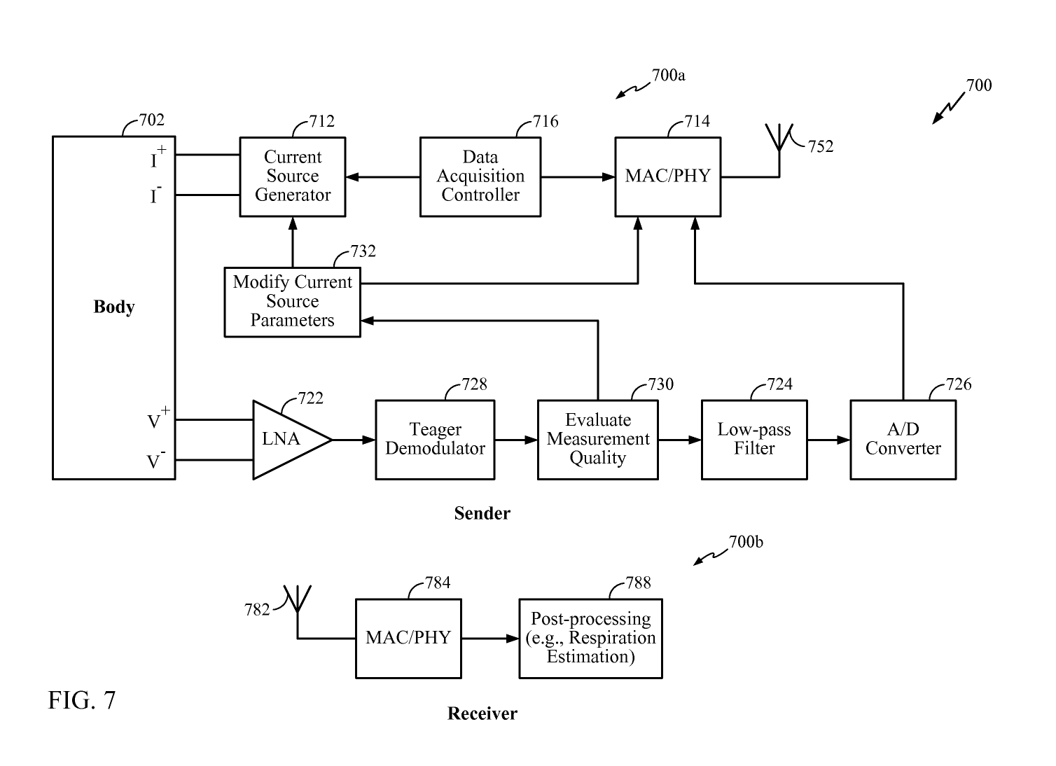

FIG. 7 illustrates another example system 700 based on EIT for determining the respiration rate of human body, where parameters of a current source generator 712 may be adapted based on spectral analysis of the demodulated waveform. This approach may allow the maximization of a quality (e.g., of an SNR) of the desired measurements. The modules and elements shown in FIG. 7 are described and operate similarly as the similarly numbered modules in previous figures, except that the first number corresponds to the figure (e.g., the description for the MAC/PHY 714 is the same as the description for the MAC/PHY 614, etc.).

As illustrated in FIG. 7, a measurement quality evaluation module 730 may be coupled to a Teager demodulator 728 to receive measurements from the demodulator. The measurement quality evaluation module 730 may then modify the operation of the current source generator 712 and the MAC/PHY module 714. For example, the measurement quality evaluation module 730 may increase a drive current via a module 732 interfaced with the current source generator 712, or actuate the drive current in a different manner.

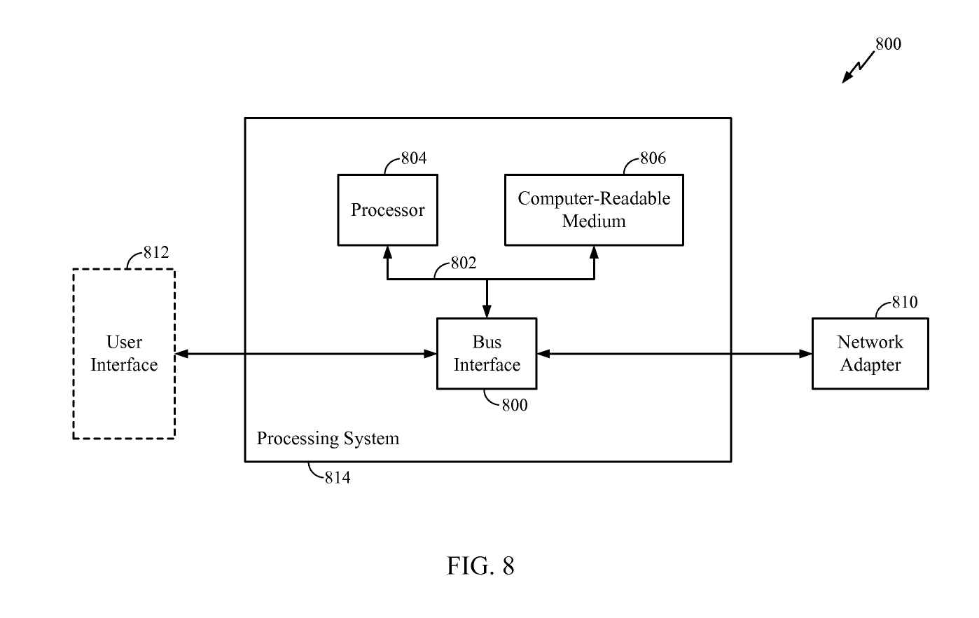

FIG. 8 illustrates an example of hardware configuration for a processing system 800 in a sensing circuit that may implement the methods described herein to measure body impedance. In this example, the processing system 800 may be implemented with a bus architecture represented generally by bus 802. The bus 802 may comprise any number of interconnecting buses and bridges depending on the specific application of the processing system 800 and the overall design constraints. The bus links together various circuits including a processor 804, computer-readable media 806, and a bus interface 808. The bus interface 808 may be used to connect a network adapter 810, among other things, to the processing system 800 via the bus 802. The network interface 810 may be used to implement the signal processing functions of the PHY layer. A user interface 812 (e.g., keypad, display, mouse, joystick, etc.) may also be connected to the bus via the bus interface 808. The bus 802 may also link various other circuits such as timing sources, peripherals, voltage regulators, power management circuits, and the like, which are well known in the art, and therefore, will not be described any further.

The processor 804 may be responsible for managing the bus and general processing, including the execution of software stored on the computer-readable media 808. The processor 804 may be implemented with one or more general-purpose and/or special-purpose processors. Examples include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

One or more processors in the processing system 800 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. A computer-readable medium may comprise, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, a carrier wave, a transmission line, or any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may comprise a computer-readable medium in packaging materials.

In the hardware implementation illustrated in FIG. 8, the computer-readable media 806 is illustrated as part of the processing system 800 separate from the processor 804. However, as those skilled in the art will readily appreciate, the computer-readable media 806, or any portion thereof, may be external to the processing system 800. By way of example, the computer-readable media 806 may comprise a transmission line, a carrier wave modulated by data, and/or a computer product separate from the wireless node, all which may be accessed by the processor 804 through the bus interface 808. Alternatively, or in addition to, the computer readable media 806, or any portion thereof, may be integrated into the processor 804, such as the case may be with cache and/or general register files.

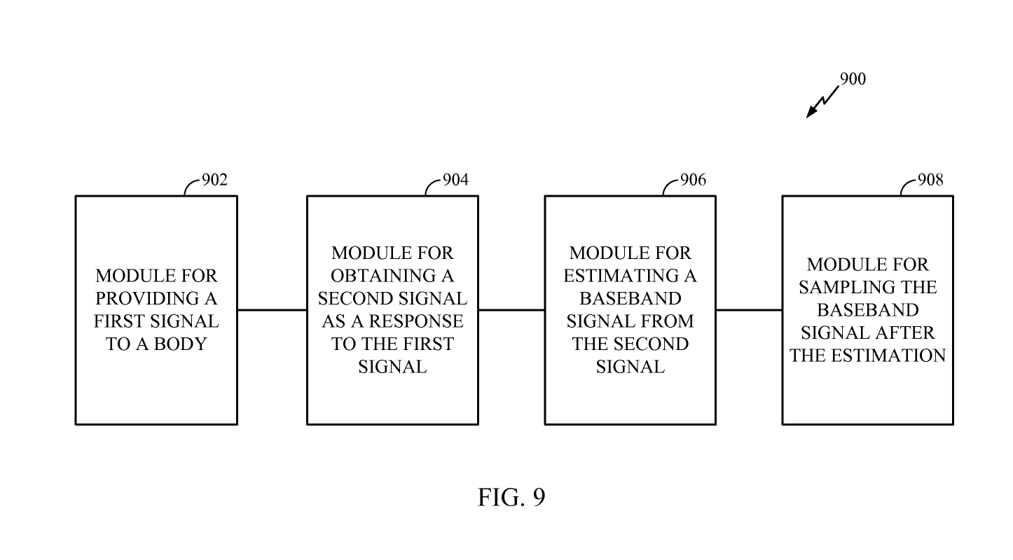

FIG. 9 is an example diagram illustrating the functionality of an apparatus 900 in accordance with one aspect of the present disclosure. The apparatus 900 may comprise a module 902 for providing a first signal to a body; a module 904 for obtaining a second signal as a response to the first signal; a module 906 for estimating in analog domain a baseband signal from the second signal; and a module 908 for sampling the baseband signal after the estimation.

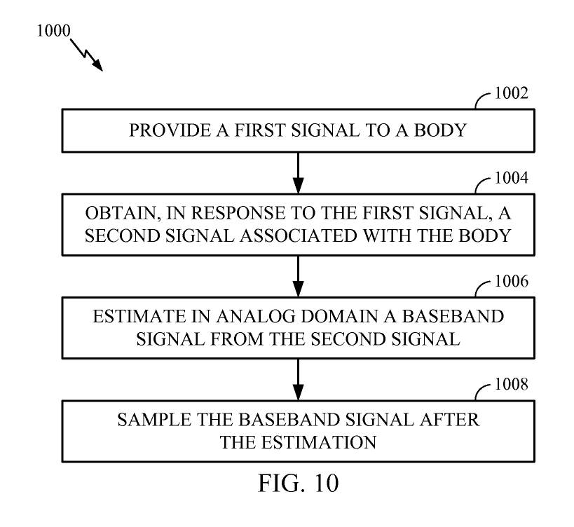

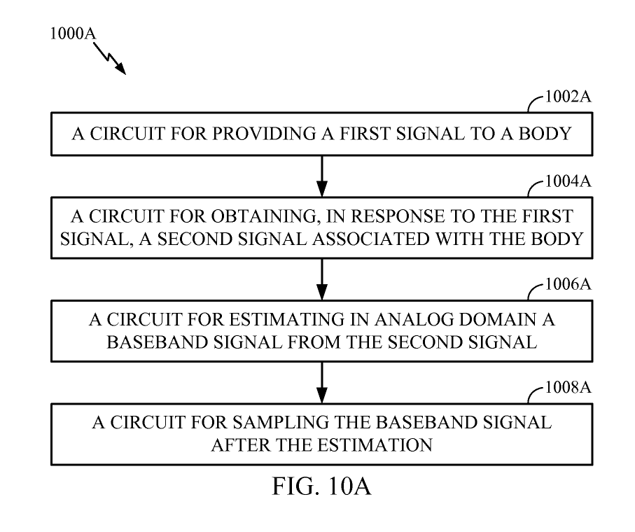

FIG. 10 illustrates example operations 1000 that may be performed at a device of an EIT system (e.g., at the sender 300a from FIG. 3, the sender 500a from FIG. 5, the sender 600a from FIG. 6, the sender 700a from FIG. 7, the processing system 800 from FIG. 8, or the apparatus 900 from FIG. 9) in accordance with certain aspects of the present disclosure. At 1002, the device may provide a first signal to a body. At 1004, in response to the first signal, a second signal associated with the body may be obtained. At 1006, a baseband signal may be estimated in analog domain from the second signal. At 1008, the baseband signal may be sampled after the estimation. According to certain aspects of the present disclosure, the sampled baseband signal may be packetized and transmitted over a wireless channel to a receiver device for processing of the sampled baseband signal.

In an aspect, the first signal may comprise a current signal and the second signal may comprise a voltage signal. In an aspect, the device may also provide a third signal based on the estimated baseband signal (e.g., a signal at the output of module 730 from FIG. 7), wherein the third signal may comprise at least one of one or more frequency components of the baseband signal or a measure of quality of the baseband signal. In an aspect, a circuit of the device (e.g., the module 732 from FIG. 7) may be configured to adjust providing the first signal to the body based on the at least one of the one or more frequency components or the measure of quality. For example, the measure of quality may comprise SNR associated with the baseband signal.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering. For example, operations 1000 illustrated in FIG. 10 correspond to components 1000A illustrated in FIG. 10A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

For example, the means for providing may comprise an application specific integrated circuit, e.g., the processor 204 of the wireless device 202 from FIG. 2, the circuit 312 from FIG. 3, the circuit 512 from FIG. 5, the circuit 612 from FIG. 6, the circuit 712 from FIG. 7, the processor 804 from FIG. 8, or the module 902 from FIG. 9. The means for obtaining may comprise an application specific integrated circuit, e.g., the processor 204, the circuit 322 from FIG. 3, the circuit 522 from FIG. 5, the circuit 622 from FIG. 6, the circuit 722 from FIG. 7, the processor 804, or the module 904 from FIG. 9. The means for estimating may comprise an application specific integrated circuit, e.g., the processor 204, the demodulator 328 from FIG. 3, the demodulator 528 from FIG. 5, the demodulator 628 from FIG. 6, the demodulator 728 from FIG. 7, the processor 804 from FIG. 8, or the module 906 from FIG. 9. The means for sampling may comprise an application specific integrated circuit, e.g., the processor 204, the circuit 326 from FIG. 3, the circuit 550 from FIG. 5, the circuit 626 from FIG. 6, the circuit 726 from FIG. 7, the processor 804, or the module 908 from FIG. 9. The means for performing may comprise an application specific integrated circuit, e.g., the processor 204, the demodulator 328, the demodulator 528, the demodulator 628, the demodulator 728, the processor 804, or the module 906. The means for generating may comprise an application specific integrated circuit, e.g., the processor 204, the circuit 312, the circuit 512, the circuit 612, the circuit 712, the processor 804, or the module 902. The means for transmitting may comprise a transmitter, e.g., the transmitter 210 of the wireless device 202 from FIG. 2, the transmitter 352 from FIG. 3, the transmitter 552 from FIG. 5, the transmitter 652 from FIG. 6, or the transmitter 752 from FIG. 7. The means for adjusting may comprise an application specific integrated circuit, e.g., the processor 204, the circuit 732 from FIG. 7, or the processor 804.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

A wireless device in the present disclosure may include various components that perform functions based on signals that are transmitted by or received at the wireless device. A wireless device may also refer to a wearable wireless device. In some aspects the wearable wireless device may comprise a wireless headset or a wireless watch. For example, a wireless headset may include a transducer adapted to provide audio output based on data received via a receiver. A wireless watch may include a user interface adapted to provide an indication based on data received via a receiver. A wireless sensing device may include a sensor adapted to provide data to be transmitted via a transmitter.

A wireless device may communicate via one or more wireless communication links that are based on or otherwise support any suitable wireless communication technology. For example, in some aspects a wireless device may associate with a network. In some aspects the network may comprise a personal area network (e.g., supporting a wireless coverage area on the order of 30 meters) or a body area network (e.g., supporting a wireless coverage area on the order of 10 meters) implemented using ultra-wideband technology or some other suitable technology. In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., transmitter 210 and receiver 212) that may include various components (e.g., signal generators and signal processors) that facilitate communication over a wireless medium.

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”) or so-called smart-phone, an entertainment device (e.g., a portable media device, including music and video players), a headset (e.g., headphones, an earpiece, etc.), a microphone, a medical sensing device (e.g., a biometric sensor, a heart rate monitor, a pedometer, an EKG device, a smart bandage, etc.), a user I/O device (e.g., a watch, a remote control, a light switch, a keyboard, a mouse, etc.), an environment sensing device (e.g., a tire pressure monitor), a monitoring device that may receive data from the medical or environment sensing device (e.g., a desktop, a mobile computer, etc.), a point-of-care device, a hearing aid, a set-top box, or any other suitable device. The monitoring device may also have access to data from different sensing devices via connection with a network.

These devices may have different power and data requirements. In some aspects, the teachings herein may be adapted for use in low power applications (e.g., through the use of an impulse-based signaling scheme and low duty cycle modes) and may support a variety of data rates including relatively high data rates (e.g., through the use of high-bandwidth pulses).

In some aspects a wireless device may comprise an access device (e.g., an access point) for a communication system. Such an access device may provide, for example, connectivity to another network (e.g., a wide area network such as the Internet or a cellular network) via a wired or wireless communication link. Accordingly, the access device may enable another device (e.g., a wireless station) to access the other network or some other functionality. In addition, it should be appreciated that one or both of the devices may be portable or, in some cases, relatively non-portable. Also, it should be appreciated that a wireless device also may be capable of transmitting and/or receiving information in a non-wireless manner (e.g., via a wired connection) via an appropriate communication interface.

While the foregoing is directed to aspects of the present disclosure, other and further aspects of the disclosure may be devised without departing from the basic scope thereof, and the scope thereof is determined by the claims that follow.

1. An apparatus, comprising:
a signal generator configured to provide a first signal to a body;
a first circuit configured to obtain, in response to the first signal, a second signal associated with the body;
a second circuit configured to estimate in analog domain a baseband signal from the second signal; and
a third circuit configured to sample the baseband signal after the estimation.

2. The apparatus of claim 1, wherein the first signal comprises a current signal, and the second signal comprises a voltage signal.

3. The apparatus of claim 1, wherein the second circuit is also configured to perform Teager demodulation of the second signal in analog domain to estimate the baseband signal.

4. The apparatus of claim 1, wherein the third circuit is also configured to sample the baseband signal according to compressed sensing (CS) based random sampling.

5. The apparatus of claim 1, wherein the signal generator is configured to generate the first signal at two or more non-uniform time instants.

6. The apparatus of claim 5, wherein the two or more non-uniform time instants are determined based on the estimated baseband signal.

7. The apparatus of claim 1, further comprising:
a fourth circuit configured to provide a third signal based on the estimated baseband signal,
wherein the third signal comprises at least one of one or more frequency components of the baseband signal or a measure of quality of the baseband signal.

8. The apparatus of claim 7, further comprising:
a fifth circuit configured to adjust providing the first signal to the body based on the at least one of the one or more frequency components or the measure of quality.

9. The apparatus of claim 1, wherein the third circuit is also configured to sample the estimated baseband signal at two or more non-uniform time instants.

10. The apparatus of claim 9, wherein the two or more non-uniform time instants are determined based on the estimated baseband signal.

11. The apparatus of claim 1, further comprising:
a fourth circuit configured to packetize the sampled baseband signal; and
a transmitter configured to transmit the packetized signal over a wireless channel.

12. A method, comprising:
providing a first signal to a body;
obtaining, in response to the first signal, a second signal associated with the body;
estimating in analog domain a baseband signal from the second signal; and
sampling the baseband signal after the estimation.

13. The method of claim 12, wherein the first signal comprises a current signal, and the second signal comprises a voltage signal.

14. The method of claim 12, wherein estimating the baseband signal comprises:
performing Teager demodulation of the second signal in analog domain.

15. The method of claim 12, wherein the baseband signal is sampled according to compressed sensing (CS) based random sampling.

16. The method of claim 12, wherein providing the first signal comprises:
generating the first signal at two or more non-uniform time instants.

17. The method of claim 16, wherein the two or more non-uniform time instants are determined based on the estimated baseband signal.

18. The method of claim 12, further comprising:
providing a third signal based on the estimated baseband signal,
wherein the third signal comprises at least one of one or more frequency components of the baseband signal or a measure of quality of the baseband signal.

19. The method of claim 18, further comprising:
adjusting of providing the first signal to the body based on the at least one of the one or more frequency components or the measure of quality.

20. The method of claim 12, wherein the estimated baseband signal is sampled at two or more non-uniform time instants.

21. The method of claim 20, wherein the two or more non-uniform time instants are determined based on the estimated baseband signal.

22. The method of claim 12, further comprising:
packetizing the sampled baseband signal; and
transmitting the packetized signal over a wireless channel.

23. An apparatus, comprising:
means for providing a first signal to a body;
means for obtaining, in response to the first signal, a second signal associated with the body;
means for estimating in analog domain a baseband signal from the second signal; and
means for sampling the baseband signal after the estimation.

24. The apparatus of claim 23, wherein the first signal comprises a current signal, and the second signal comprises a voltage signal.

25. The apparatus of claim 23, further comprising:
means for performing Teager demodulation of the second signal in analog domain to estimate the baseband signal.

26. The apparatus of claim 23, further comprising:
means for sampling the baseband signal according to compressed sensing (CS) based random sampling.

27. The apparatus of claim 23, further comprising:
means for generating the first signal at two or more non-uniform time instants.

28. The apparatus of claim 27, wherein the two or more non-uniform time instants are determined based on the estimated baseband signal.

29. The apparatus of claim 23, further comprising:
means for providing a third signal based on the estimated baseband signal,
wherein the third signal comprises at least one of one or more frequency components of the baseband signal or a measure of quality of the baseband signal.

30. The apparatus of claim 29, further comprising:
means for adjusting of providing the first signal to the body based on the at least one of the one or more frequency components or the measure of quality.

31. The apparatus of claim 23, further comprising:
means for sampling the estimated baseband signal at two or more non-uniform time instants.

32. The apparatus of claim 31, wherein the two or more non-uniform time instants are determined based on the estimated baseband signal.

33. The apparatus of claim 23, further comprising:
means for packetizing the sampled baseband signal; and
means for transmitting the packetized signal over a wireless channel.

34. A computer-program product, comprising a computer-readable medium comprising instructions executable to:
provide a first signal to a body;
obtain, in response to the first signal, a second signal associated with the body;
estimate in analog domain a baseband signal from the second signal; and
sample the baseband signal after the estimation.

35. A sensing device, comprising:
a signal generator configured to provide a first signal to a body;
a sensor configured to sense, in response to the first signal, a second signal associated with the body;
a first circuit configured to estimate in analog domain a baseband signal from the second signal; and
a second circuit configured to sample the baseband signal after the estimation.
